(19) United States
(12) Patent Application Publication
(10) Pub. No.: US 2013/0275042 A1
(43) Pub. Date: Oct. 17, 2013

(54) USER EQUIPMENT FOR DISPLAYING MAP AND METHOD FOR DISPLAYING MAP

(71) Applicant: JH INVESTMENTS LLC, Seoul (KR)

(72) Inventor: Jee Hoon PARK, Seoul (KR)

(73) Assignee: JH Investments LLC, Seoul (KR)

(21) Appl. No.: 13/857,999

(22) Filed: Apr. 6, 2013

(30) Foreign Application Priority Data
Apr. 12, 2012 (KR) 10-2012-0037973

(51) Int. Cl. G06T 3/60

(52) U.S. Cl. CPC G06T 3/60
USPC 701/461; 701/533; 345/649

(57) ABSTRACT

User equipment includes a storage unit for separately storing map data, POI (Point Of Interest) information, and location information of the POI information on the map data, a map output unit for displaying the POI information on a screen based on the location information of the POI information so that the POI information is overlapped with the map data in parallel to the lateral axis of the user equipment, and a rotation angle calculating unit for calculating a rotation angle for the rotation of the map data. The map output unit rotates the map data and the POI information, which are displayed on the screen in an overlapping state, according to the rotation angle so that the POI information is disposed in parallel to the lateral axis of the user equipment after rotation.

### CROSS-REFERENCE TO RELATED APPLICATION AND CLAIM OF PRIORITY

The present application claims priority to Korean Patent Application No. 10-2012-0037973 filed in the Republic of Korea on Apr. 12, 2012, the disclosures of which are incorporated herein by reference.

### BACKGROUND

1. Field of the Disclosure

The present disclosure relates to user equipment for rotating and displaying a map and a method for displaying a map.

2. Description of the Related Art

User equipment (UE) such as a smart phone currently released in the market has various functions desired by users, for example the map service, as well as basic functions for calling. The map service displays a region where the user equipment is located on a map and provides information about the region to give a guide service.

In such map service, map information includes map data and POI (Point Of Interest) information. Here, the POI information is text and image contents of facilities, stations, airports, terminals, hotels or the like and is displayed to be integrally incorporated with the map data. Therefore, if the map rotates by means of a direction sensor included in the user equipment or if a user intentionally rotates the map, the displayed POI information is also rotated.

However, since the displayed POI information is integrally incorporated with the map data, after the map rotates, the POI information does not keep its horizontal status from a user viewpoint but is inclined by the rotation angle and displayed. For this reason, the user may not instantly figure out the information about a desired point on the map. For example, even though the POI information initially displayed on the map keeps its horizontal status, if the map rotates, the POI information is displayed in an inclined state since the POI information is integrally incorporated with the map data, which greatly deteriorates legibility of the user about the POI information and cognitive power on the POI.

### SUMMARY

One or more embodiments of the present disclosure is designed to solve the problems of the prior art, and therefore it is an object of one or more embodiments of the present disclosure to provide user equipment and a map displaying method for improving legibility of a user about POI information even though a map rotates, by separating the POI information from map data.

Other objects and advantages of the present disclosure will be understood from the following description and become more apparent by embodiments of the present disclosure. In addition, it could be easily understood that the objects and advantages of the present disclosure can be implemented by components defined in the claims or their combinations.

In an aspect of the present disclosure, there is provided user equipment, which includes a storage unit for separately storing map data, POI (Point Of Interest) information, and location information of the POI information on the map data; a map output unit for displaying the POI information on a screen based on the location information of the POI information so that the POI information is overlapped with the map data in parallel to the lateral axis of the user equipment; and a rotation angle calculating unit for calculating a rotation angle for the rotation of the map data, wherein the map output unit rotates the map data and the POI information, which are displayed on the screen in an overlapping state, according to the rotation angle so that the POI information is disposed in parallel to the lateral axis of the user equipment after rotation.

The rotation angle calculating unit may calculate the rotation angle of the user equipment by using a direction sensor.

The rotation angle calculating unit may calculate an angle between the longitudinal axis of the user equipment and the true north as the rotation angle by using a direction sensor.

The rotation angle calculating unit may calculate the rotation angle according to a map rotating command input by a user on a touch screen.

The user equipment may further include a location measuring unit for measuring a current location; and a map receiving unit for transmitting the current location to a map server, receiving map data, POI information and location information of a POI within a predetermined radius based on the current location from the map server, and storing the data and information in the storage unit.

The location information of the POI may be polar coordinates using the current location as a starting point, and the map output unit may rotate the map data and the POI information based on the current location.

The POI information may be a string in which location information is stored for each character to be disposed on the map data according to a geographic feature on the map, and the map output unit may dispose characters of the string in parallel to the lateral axis of the user equipment.

In the case the characters of the string are arranged in a direction opposite to a reference direction after rotation, the map output unit may change an arrangement order of the corresponding characters to conform to the reference direction.

The map output unit may arrange only POI information within a predetermined radius based on a center of the screen to be disposed in parallel to the lateral axis after rotation.

The map output unit may arrange only POI information within a predetermined distance from a path for guiding a way to a destination to be disposed in parallel to the lateral axis after rotation.

In another aspect of the present disclosure, there is also provided a method for displaying a map at user equipment, which includes a storing step for separately storing map data, POI (Point Of Interest) information, and location information of the POI information on the map data; a map outputting step for displaying the POI information on a screen based on the location information of the POI information so that the POI information is overlapped with the map data in parallel to the lateral axis of the user equipment; a rotation angle calculating step for calculating a rotation angle for the rotation of the map data; and a map rotating step for rotating the map data and the POI information, which are displayed on a screen in an overlapping state, according to the rotation angle and disposing the POI information in parallel to the lateral axis of the user equipment after rotation.

The rotation angle calculating step may calculate the rotation angle of the user equipment by using a direction sensor.

The rotation angle calculating step may calculate an angle between the longitudinal axis of the user equipment and the true north as the rotation angle by using a direction sensor.

The rotation angle calculating step may calculate the rotation angle according to a map rotating command input by a user on a touch screen.

Before the storing step, the method may further include measuring a current location; and transmitting the current location to a map server and receiving map data, POI information and location information of a POI within a predetermined radius based on the current location from the map server.

The location information of the POI may be polar coordinates using the current location as a starting point, and the map rotating step may rotate the map data and the POI information based on the current location.

The POI information may be a string in which location information is stored for each character to be disposed on the map data according to a geographic feature on the map, and the map outputting step may dispose characters of the string in parallel to the lateral axis of the user equipment.

The map rotating step may change an arrangement order of the characters to conform to a reference direction in the case the corresponding characters of the string are arranged in a direction opposite to the reference direction after rotation.

The map rotating step may arrange only POI information within a predetermined radius based on a center of the screen to be disposed in parallel to the lateral axis after rotation.

The map outputting step may include outputting a path for guiding a way to a destination, and the map rotating step may arrange only POI information within a predetermined distance from the path to be disposed in parallel to the lateral axis after rotation.

The present disclosure improves legibility about POI information on a map by separating the POI information from map data so that the POI information keeps its horizontal status from a user viewpoint even though the map rotates.

In addition, the present disclosure may reduce operation quantity for map processing of the user equipment and allow instant user interfacing by keeping a horizontal status only for POI information within a predetermined radius based on a location of the user equipment or within a predetermined distance from a path for guiding a way when the map is rotating.

Moreover, the present disclosure may improve legibility and cognitive power about POI information on the map by keeping a direction of POI information to be read in a fixed direction even though the map rotates, if the POI information needs to be arranged in parallel to a geographic feature on the map according to a pattern of the corresponding geographic feature.

### BRIEF DESCRIPTION OF THE DRAWINGS

FIG. 1 is a block diagram showing user equipment for displaying a map according to an embodiment of the present disclosure.

FIG. 2 is a diagram showing a map which rotates by a touch of a user according to an embodiment of the present disclosure.

FIG. 3 is a diagram showing a map which rotates by a rotation of the user equipment according to an embodiment of the present disclosure.

FIG. 4 is a diagram showing a map which rotates by separately inputting the longitudinal axis of the user equipment and the true north according to an embodiment of the present disclosure.

FIGS. 5A and 5B are diagrams for illustrating a method for displaying POI information, which is disposed in accordance with a geographic feature on the map, on the map according to embodiments of the present disclosure.

FIG. 6 is a flowchart for illustrating a method for rotating a map at user equipment according to an embodiment of the present disclosure.

FIG. 7 is a flowchart for illustrating a method for rotating a map at user equipment according to another embodiment of the present disclosure.

FIG. 8 is a block diagram showing user equipment for displaying a map according to another embodiment of the present disclosure.

FIG. 9 is a flowchart for illustrating a method for rotating a map at user equipment according to another embodiment of the present disclosure.

FIG. 10 is a block diagram showing user equipment for displaying a map according to still another embodiment of the present disclosure.

### DETAILED DESCRIPTION

Other objects, features and advantages of the present invention will become apparent from the following descriptions of the embodiments with reference to the accompanying drawings, from which it will be deemed that a person having ordinary skill can easily practice the technical spirit of the present invention. Also, any explanation of the prior art known to relate to the present invention may be omitted if it is regarded to render the subject matter of the present invention vague. Hereinafter, exemplary embodiments of the present invention will be described in detail with reference to the accompanying drawings.

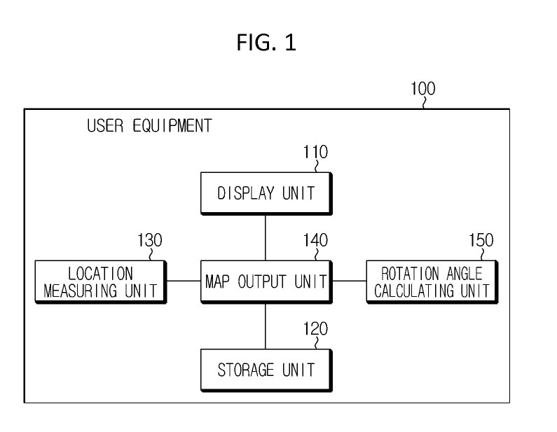

FIG. 1 is a block diagram showing user equipment for displaying a map according to an embodiment of the present disclosure.

Referring to FIG. 1, the user equipment 100 of this embodiment includes a display unit 110, a storage unit 120, a location measuring unit 130, a map output unit 140 and a rotation angle calculating unit 150.

The display unit 110 is a display such as a liquid crystal display (LCD) for displaying map data and POI information output from the map output unit 140.

The storage unit 120 separately stores map data, POI (Point Of Interest) information, and location information of the POI information, which are to be displayed by the display unit 110.

Here, the map data may be an image file, and the location information of the POI information may be latitude/longitude coordinates, or polar coordinates or orthogonal coordinates on a planar coordinate system using a specific point as a starting point. The POI means a point or object of interest, which may be a building, a road, a river or the like. The POI information may be a string or image for such POI.

In the POI information, location information of the center of the POI information is stored as the location information of the POI information disposed in parallel to the lateral axis of the user equipment 100. Meanwhile, in POI information which should be disposed according to a geographic feature on the map in parallel to the corresponding geographic feature, for example location information of a string such as ‘J Bridge’, location information of each character of the string is stored.

The location measuring unit 130 includes a GPS receiver to receive a satellite signal from a satellite and measure a current location of the user equipment 100. In addition, the location measuring unit 130 may measure a current location of the user equipment 100 by using a base station in a region where a satellite signal is not received.

The map output unit 140 outputs a map to the display unit 110 by using the map data, the POI information, and the location information of the POI information, stored in the storage unit 120. The map output unit 140 outputs the POI information to the display unit 110 by using the location information of the POI information so that the POI information is overlapped with the map data. At this time, the map output unit 140 disposes the POI information in parallel to the lateral axis of the user equipment 100 and outputs the POI information.

When information about a map is checked, a user generally places user equipment in a widthwise direction. Therefore, in this embodiment and following embodiments, the lateral axis of the user equipment 100 is described as a vertical axis in the viewpoint of the user, and the longitudinal axis of the user equipment 100 is described as a horizontal axis in the viewpoint of the user. In the case the user places and uses user equipment in a lengthwise direction, the technical spirit of the present disclosure may also be applied after changing only a reference direction correspondingly.

The map output unit 140 may output the map data and the POI information so that a current location of the user equipment 100 measured by the location measuring unit 130 is positioned at the center of the display unit 110 and the north on the map is matched with the longitudinal axis of the user equipment 100, without being limited thereto.

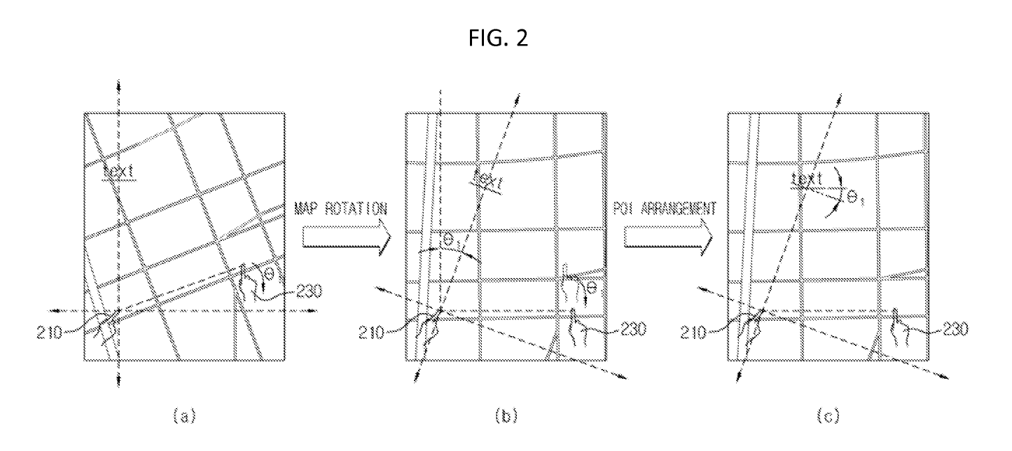

The map output unit 140 outputs the map data and the POI information to the display unit 110 in an overlapping state and then rotates and outputs the map data and the POI information as much as a rotation angle, calculated by the rotation angle calculating unit 150 for the rotation of the map data. After the rotation, the map output unit 140 rearranges the POI information to be in parallel to the lateral axis of the user equipment 100. This will be described later in more detail with reference to FIGS. 2 to 4. Here, the rotation angle represents an angle in which a rotating direction is also considered.

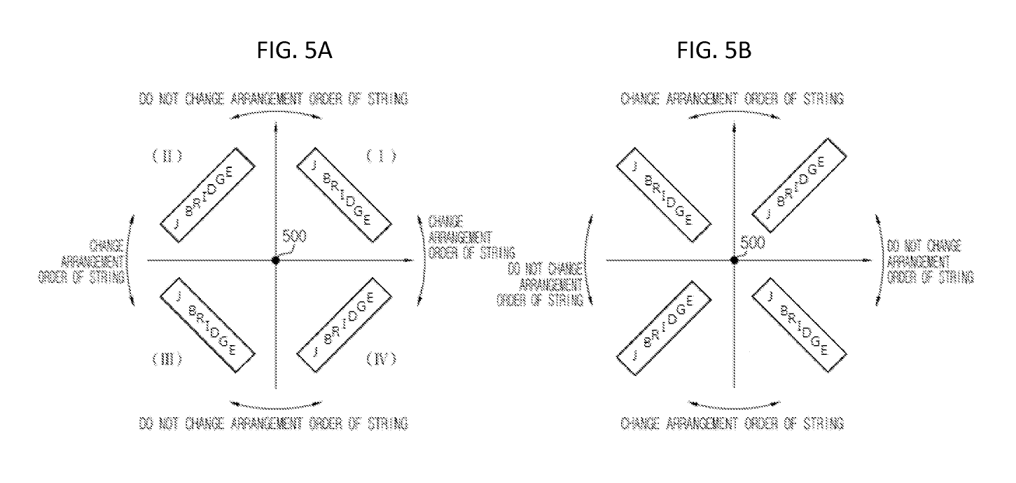

In addition, in case of a string (for example, ‘J Bridge’) which is POI information that should be disposed according to a geographic feature on the map in parallel to the corresponding geographic feature, the map output unit 140 rotates the corresponding string together with the map when the map is rotated. In this case, if the corresponding string is read in a direction different from a reference direction after rotation, the map output unit 140 may change an arrangement order of characters of the corresponding string to conform to the reference direction. This will be described later in more detail with reference to FIGS. 5A and 5B.

In order to reduce the operation quantity, the map output unit 140 may limitedly rearrange only POI information within a predetermined radius based on the current location of the user equipment 100 to be in parallel to the lateral axis of the user equipment, after the map is rotated.

The rotation angle calculating unit 150 calculates a rotation angle for the rotation of the map data. The rotation angle calculating unit 150 analyzes an input of a user interface, specifically an input of a scroll bar used for rotating a map, to calculate a rotation angle according to the push on the scroll bar, and transmits the calculated rotation angle to the map output unit 140.

In addition, the rotation angle calculating unit 150 analyzes a touch for rotating a map, input by the user, on a touch screen having touch sensors to calculate a rotation axis and a rotation angle of the map and transmits the calculated results to the map output unit 140.

For example, the user may rotate a map by using two fingers on the touch screen. At this time, one finger fixed in contact with the touch screen may be recognized as a rotation axis and the other finger which is moving may be recognized as a rotating direction. The recognized information is transmitted to the map output unit 140.

In addition, the rotation angle calculating unit 150 may transmit the rotation angle of the user equipment 100 to the map output unit 140 by using a direction sensor.

FIG. 2 is a diagram showing a map which rotates by a touch of a user according to an embodiment of the present disclosure.

Referring to (a) of FIG. 2, the map output unit 140 of the user equipment 100 outputs a map, where the POI information is overlapped on the screen of the display unit 110, by using the map data, the POI information, and the location information of the POI information, stored in the storage unit 120. Here, the POI information may be a string, which is ‘text’, and its location information may be location coordinates at the center of the ‘text’ string. The location coordinates may be latitude/longitude coordinates, or polar coordinates or orthogonal coordinates using a specific point of the map data as a starting point. When outputting the initial POI information to be overlapped with the map data, the map output unit 140 disposes the string of the POI information in parallel to the lateral axis of the user equipment 100.

In a state where the map is output as shown in (a) of FIG. 2, the user touches two fingers to the touch screen, and then fixes one finger 210 and moves the other finger 230 in the clockwise direction. At this time, the rotation angle calculating unit 150 calculates a rotation angle θ1 according to the movement of the other finger 230 in the clockwise direction by using the fixed finger 210 as a rotation axis, and the map output unit 140 rotates the map data and the POI information in the clockwise direction as much as the rotation angle θ1 based on the rotation axis 210.

Accordingly, as shown in (b) of FIG. 2, the POI information, namely the ‘text’ string, is inclined as much as θ1 in the clockwise direction from the lateral axis of the user equipment 100 due to the rotation. Here, the map output unit 140 rearranges the inclined POI information, namely ‘text’ string, to be in parallel to the lateral axis of the user equipment 100. In other words, as shown in (c) of FIG. 2, the ‘text’ string is rotated as much as θ1 in the counterclockwise direction based on the lateral axis of the user equipment 100.

Therefore, even though the map is rotated by the user, the POI information overlapped on the map is rearranged to be in parallel to the lateral axis of the user equipment 100, thereby improving legibility for the POI information.

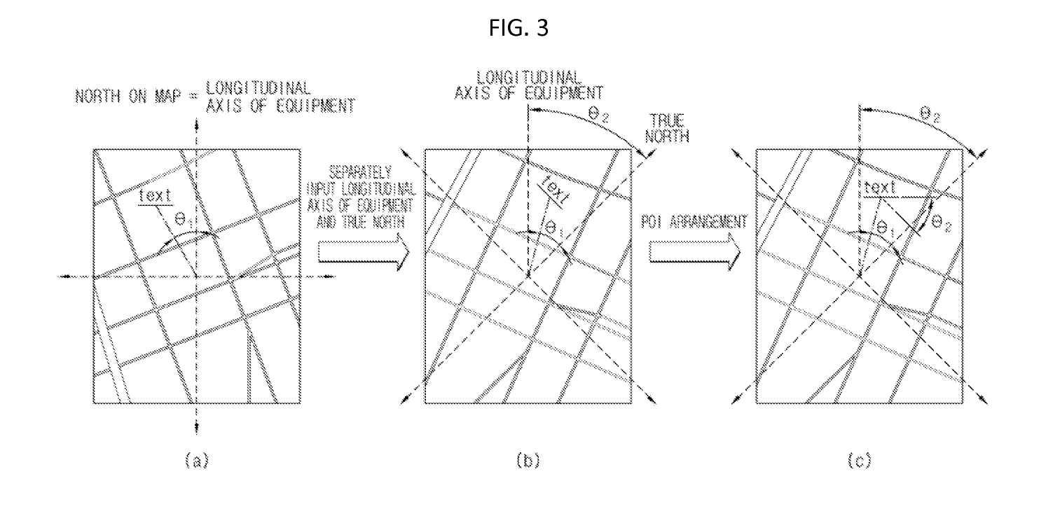

FIG. 3 is a diagram showing a map which rotates by a rotation of the user equipment according to an embodiment of the present disclosure.

Referring to (a) of FIG. 3, the map output unit 140 of the user equipment 100 outputs a map overlapped with the POI information on the screen of the display unit 110 by using the map data, the POI information, and the location information of the POI information, stored in the storage unit 120. Here, the POI information may be a string, which is ‘text’, and its location information may be location coordinates at the center of the ‘text’ string. The location coordinates may be latitude/longitude coordinates, or polar coordinates or orthogonal coordinates using a specific point of the map data as a starting point. When outputting the initial POI information to be overlapped with the map data, the map output unit 140 disposes the string of the POI information in parallel to the lateral axis of the user equipment 100.

After that, if the user equipment 100 rotates as much as θ2 in the counterclockwise direction, for example if the user possessing the user equipment 100 turns in the counterclockwise direction on the spot, the rotation angle calculating unit 150 calculates the rotation angle θ2 by using the direction sensor. As shown in (b) of FIG. 3, the map output unit 140 rotates the map overlapped with the POI information, displayed on the display unit 110, as much as θ2 in the clockwise direction by using the center of the map as a rotation axis.

Accordingly, as shown in (b) of FIG. 3, the POI information, namely the ‘text’ string, is inclined as much as θ2 in the clockwise direction from the lateral axis of the user equipment 100 due to the rotation. Here, the map output unit 140 rearranges the inclined POI information, namely ‘text’ string, to be in parallel to the lateral axis of the user equipment 100. In other words, as shown in (c) of FIG. 3, the ‘text’ string is rotated as much as θ2 in the counterclockwise direction based on the lateral axis of the user equipment 100.

Therefore, even though the map is rotated due to the rotation of the user equipment 100, the POI information overlapped on the map is rearranged to be in parallel to the lateral axis of the user equipment 100, thereby improving legibility for the POI information.

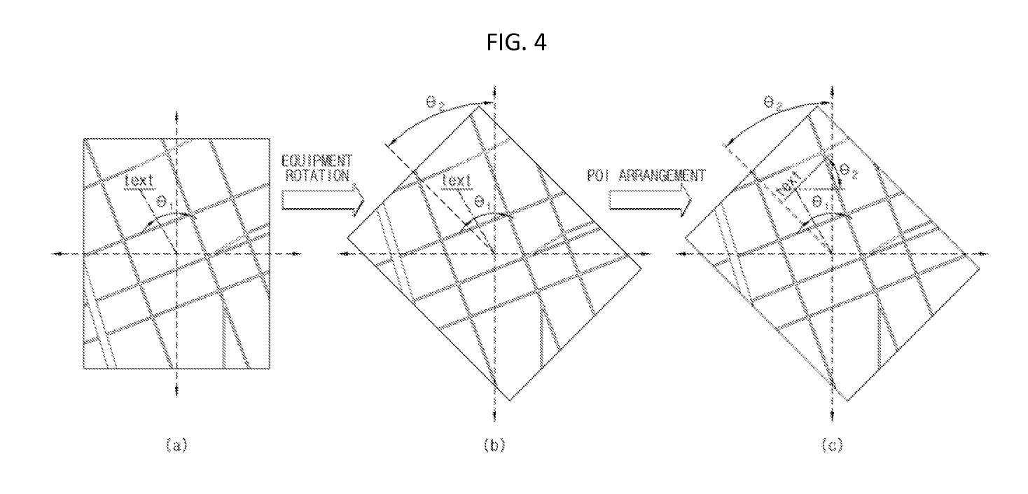

FIG. 4 is a diagram showing a map which rotates by separately inputting the longitudinal axis of the user equipment and the true north according to another embodiment of the present disclosure.

When displaying a map on a screen of user equipment, a map application of a mobile communication terminal such as a smart phone generally matches the longitudinal axis of the terminal with the north on the map. In other words, referring to (a) of FIG. 4, when outputting a map overlapped with the POI information to the screen of the display unit 110 by using the map data, the POI information, and the location information of the POI information, stored in the storage unit 120, the map output unit 140 of the user equipment 100 matches the longitudinal axis of the user equipment 100 with the north on the map.

Here, the POI information may a string, which is ‘text’, and its location information may location coordinates at the center of the ‘text’ string. The location coordinates may be latitude/longitude coordinates, or polar coordinates or orthogonal coordinates using a specific point of the map data as a starting point. When outputting the initial POI information to be overlapped with the map data, the map output unit 140 disposes the string of the POI information in parallel to the lateral axis of the user equipment 100.

However, if the north on the map displayed on the user equipment 100 is matched with the longitudinal axis of the user equipment, the map displayed on the user equipment 100 is generally not matched with geographical east/west/south/north directions at a region where the user is currently located. Therefore, when finding a way by using the map displayed on the user equipment 100, it is not easy to figure out an accurate direction. Accordingly, it is needed to match the north on the map displayed on the user equipment 100 with the true north.

For example, as shown in FIG. 4, the user equipment 100 may separately receive the longitudinal axis of the user equipment and the true north, like an embodiment in which a map is rotated according to a true north guideline intentionally displayed on the screen, such as calibration matching (automatic, optional or the like) using a direction sensor (a digital compass, an accelerator or the like).

Accordingly, the rotation angle calculating unit 150 calculates an angle θ2 between the longitudinal axis of the user equipment and the true north, and the map output unit 140 rotates the map displayed on the display unit 110 as much as the angle θ2 toward the true north as shown in (b) of FIG. 4. Accordingly, as shown in (b) of FIG. 4, the POI information, namely the ‘text’ string, is inclined as much as θ2 in the clockwise direction from the lateral axis of the user equipment 100 due to the rotation. Here, the map output unit 140 rearranges the inclined POI information, namely ‘text’ string, to be in parallel to the lateral axis of the user equipment 100. In other words, as shown in (c) of FIG. 4, the ‘text’ string is rotated as much as θ2 in the counterclockwise direction with respect to the lateral axis of the user equipment 100.

Therefore, the north on the map displayed on the user equipment 100 is matched with the true north, which allows the user to easily figure out a direction of a desired point from his current location. In addition, even though the map rotates while matching the north on the map with the true north, the POI information overlapped with the map is rearranged in parallel to the lateral axis of the user equipment 100, thereby improving legibility for the POI information.

FIGS. 5A an 5B are diagrams for illustrating a method for displaying POI information, which is disposed in accordance with a geographic feature on the map, on the map according to an embodiment of the present disclosure.

POI information, or a string, may be disposed according to a shape of a river, a street or the like on the map regardless of the lateral axis of the user equipment. For example, the string of ‘J Bridge’ should be disposed in parallel with the bridge, rather than being always disposed in parallel to the lateral axis of the user equipment. Characters of the string should be arranged in parallel to the lateral axis of the user equipment as described above with reference to FIGS. 2 to 4.

An arrangement order of characters of the string may be changed according to the rotation of the map, and therefore the arrangement order needs to be fixed all the time. For example, characters of the string ‘J Bridge’ are arranged so as to be read from the left to the right. However, if the map rotates, the arrangement order of the characters may be changed to be read from the right to the left, like ‘egdirB J’, which may be confusing to the user. Therefore, when the map rotates, it is needed to maintain the characters of the string are arranged in the reference direction to be read in the same direction all the time. Here, the reference direction is described as reading from the left to the right as an example, but on occasions, it may be set as reading from the right to the left.

Referring to FIG. 5A, in the first quadrant on a planar coordinate system (a planar coordinate system composed of the lateral axis and the longitudinal axis of the user equipment) using a rotation axis 500 as a starting point, if a string having a negative slope (where characters are arranged according to a reading order) moves to the second quadrant due to the rotation, the arrangement order of the characters is not changed (namely, to be read from the left to the right). Meanwhile, if the string moves from the first quadrant to the fourth quadrant, the arrangement order of the characters is changed.

However, referring to FIG. 5B, in the first quadrant on a planar coordinate system (a planar coordinate system composed of the lateral axis and the longitudinal axis of the user equipment) using the rotation axis 500 as a starting point, if a string having a positive slope moves to the second quadrant due to the rotation, the arrangement order of the characters is changed. Meanwhile, if the string moves from the first quadrant to the fourth quadrant, the arrangement order of the characters is not changed.

Next, referring to FIG. 5A, in the second quadrant on a planar coordinate system (a planar coordinate system composed of the lateral axis and the longitudinal axis of the user equipment) using the rotation axis 500 as a starting point, if a string having a positive slope moves to the third quadrant due to the rotation, the arrangement order of the characters is changed. Meanwhile, if the string moves from the second quadrant to the first quadrant, the arrangement order of the characters is not changed.

However, referring to FIG. 5B, in the second quadrant on a planar coordinate system (a planar coordinate system composed of the lateral axis and the longitudinal axis of the user equipment) using the rotation axis 500 as a starting point, if a string having a negative slope moves to the third quadrant due to the rotation, the arrangement order of the characters is not changed. Meanwhile, if the string moves from the second quadrant to the first quadrant, the arrangement order of the characters is changed.

In addition, referring to FIG. 5A, in the third quadrant on a planar coordinate system (a planar coordinate system composed of the lateral axis and the longitudinal axis of the user equipment) using the rotation axis 500 as a starting point, if a string having a negative slope moves to the second quadrant due to the rotation, the arrangement order of the characters is changed. Meanwhile, if the string moves from the third quadrant to the fourth quadrant, the arrangement order of the characters is not changed.

However, referring to FIG. 5B, in the third quadrant on a planar coordinate system (a planar coordinate system composed of the lateral axis and the longitudinal axis of the user equipment) using the rotation axis 500 as a starting point, if a string having a positive slope moves to the second quadrant due to the rotation, the arrangement order of the characters is not changed. Meanwhile, if the string moves from the third quadrant to the fourth quadrant, the arrangement order of the characters is changed.

In addition, referring to FIG. 5A, in the fourth quadrant on a planar coordinate system (a planar coordinate system composed of the lateral axis and the longitudinal axis of the user equipment) using the rotation axis 500 as a starting point, if a string having a positive slope moves to the third quadrant due to the rotation, the arrangement order of the characters is not changed. Meanwhile, if the string moves from the fourth quadrant to the first quadrant, the arrangement order of the characters is changed.

However, referring to FIG. 5B, in the fourth quadrant on a planar coordinate system (a planar coordinate system composed of the lateral axis and the longitudinal axis of the user equipment) using the rotation axis 500 as a starting point, if a string having a negative slope moves to the third quadrant due to the rotation, the arrangement order of the characters is changed. Meanwhile, if the string moves from the fourth quadrant to the first quadrant, the arrangement order of the characters is not changed.

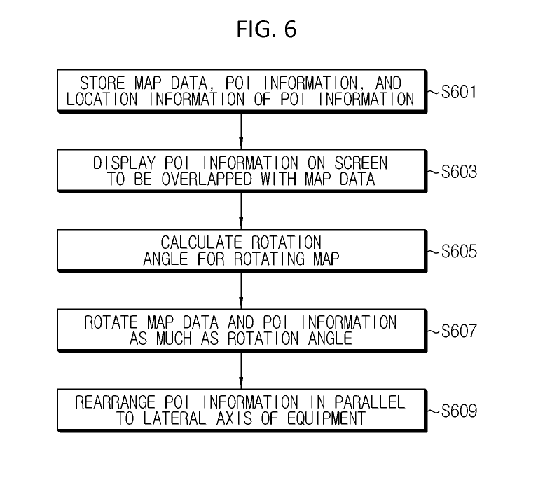

FIG. 6 is a flowchart for illustrating a method for rotating a map at user equipment according to an embodiment of the present disclosure.

Referring to FIG. 6, the user equipment 100 separately stores map data, POI (Point Of Interest) information, and location information of the POI information in the storage unit 120 (S601). Here, the POI information may be a string or image. In addition, the location information of the POI information may be location information about the center of the POI information and may be latitude/longitude coordinates, or polar coordinates or orthogonal coordinates on a planar coordinate system using a specific point of the map data as a starting point.

The user equipment 100 outputs a map to the display unit 110 by using the map data, the POI information, and the location information of the POI information, stored in the storage unit 120. In detail, the user equipment 100 outputs the map to the display unit 110 after overlapping the POI information with the map data by using the location information of the POI information and disposing the POI information in parallel to the lateral axis of the user equipment 100 (S603).

At this time, the user equipment 100 may output the POI information and the map after measuring a current location and matching the current location on the map with the center of the screen of the user equipment, or after matching an address input by the user or a point touched by the user with the center of the screen of the user equipment.

After the map is displayed as described above, the user equipment 100 calculates a rotation angle for the rotation of the map (S605). For example, an input of a user interface, specifically an input of a scroll bar for rotating the map, may be analyzed to calculate a rotation angle according to the push of the scroll bar. In other case, a touch for rotating the map, input by the user on a touch screen having touch sensors, may be analyzed to calculate a rotation axis and a rotation angle of the map. In other case, the rotation angle of the user equipment 100 may be calculated by using a direction sensor.

After the rotation angle is calculated, the user equipment 100 rotates the map data and the POI information as much as the rotation angle in the rotation direction (S607), and after the rotation, the POI information is rearranged to be in parallel to the lateral axis of the user equipment 100 (S609). An example of the rotation of the POI information according to the rotation of the map is already described above with reference to FIGS. 2 to 4.

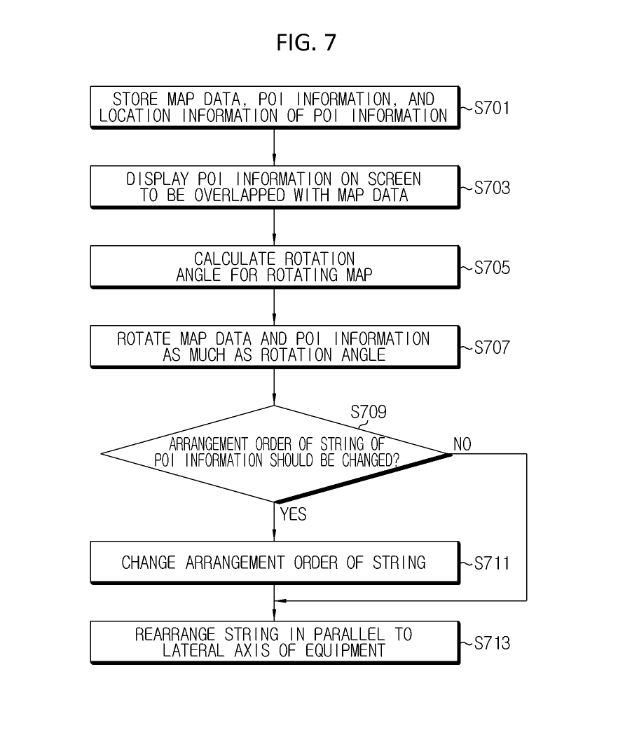

FIG. 7 is a flowchart for illustrating a method for rotating a map at user equipment according to another embodiment of the present disclosure.

Referring to FIG. 7, the user equipment 100 separately stores map data, POI (Point Of Interest) information, and location information of the POI information in the storage unit 120 (S701). Here, the POI information may be a string which should be arranged according to a geographic feature on the map in parallel to the corresponding geographic feature. In addition, the location information of the POI information may be location information of the POI information, namely location information of each character of the string, and may be latitude/longitude coordinates, or polar coordinates or orthogonal coordinates on a planar coordinate system using a specific point of the map data as a starting point. For example, if the string is composed of 4 characters, polar coordinates of the characters using the current location as a starting point are expressed like {(r1, θ1), (r2, θ2), (r3, θ3), (r3, θ3)}.

The user equipment 100 outputs a map to the display unit 110 by using the map data, the POI information, and the location information of the POI information, stored in the storage unit 120. In detail, the user equipment 100 outputs the map to the display unit 110 after overlapping the POI information with the map data by using the location information of the POI information and disposing the POI information, namely the characters of the string, in parallel to the lateral axis of the user equipment 100 (S703).

At this time, the user equipment 100 may output the POI information and the map after measuring a current location and matching the current location on the map with the center of the screen of the user equipment, or after matching an address input by the user or a point touched by the user with the center of the screen of the user equipment.

After the map is displayed as described above, the user equipment 100 calculates a rotation angle for the rotation of the map (S705). For example, an input of a user interface, specifically an input of a scroll bar for rotating the map, may be analyzed to calculate a rotation angle according to the push of the scroll bar. In other case, a touch for rotating the map, input by the user on a touch screen having touch sensors, may be analyzed to calculate a rotation axis and a rotation angle of the map. In other case, the rotation angle of the user equipment 100 may be calculated by using a direction sensor.

After the rotation angle is calculated, the user equipment 100 rotates the map data and the POI information as much as the rotation angle in the rotation direction (S707). After that, the user equipment 100 checks whether the POI information, namely the arrangement order of the characters of the string, should be changed (S709). The necessity for changing the arrangement order of characters of a string is already described above with reference to FIGS. 5A and 5B. For example, in the case the reference direction is set so that a string is read from the left to the right, of the string is changed to be read from the right to the left after the rotation based on the lateral axis of the user equipment 100, the arrangement order of characters of the string should be changed.

If the arrangement order of the characters of the string should be changed, the user equipment 100 changes the arrangement order of the characters of the string and rearranges the characters to be in parallel to the lateral axis of the user equipment 100 (S711, S713). Meanwhile, if the arrangement order of the characters of the string need not be changed, the user equipment 100 does not change the arrangement order of the characters but just rearranges the characters to be in parallel to the lateral axis of the user equipment 100 (S713).

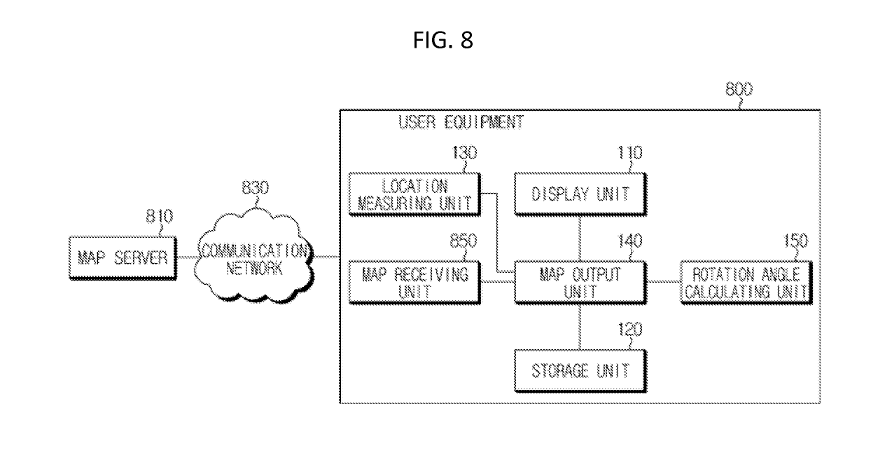

FIG. 8 is a block diagram showing user equipment for displaying a map according to another embodiment of the present disclosure. Referring to FIG. 8, user equipment 800 may communicate with a map server 810 through a communication network 830 to receive map data, POI information, and location information of the POI information.

In FIG. 8, the map server 810 is a server on which a geographic information system (GIS) engine is loaded. The map server 810 receives GPS location information of the user equipment 800 or information about a base station or a WiFi access point accessed by the user equipment 800, from the user equipment 800, and transmits map data, POI information, and location information of the POI information within a predetermined radius based on a calculated location to the user equipment 800 by using the received GPS location information or the received information about a base station information or a WiFi access point.

In FIG. 8, the same reference symbols as in FIG. 1 have all functions and operations described with reference to FIG. 1, and the user equipment 800 of FIG. 8 further includes a map receiving unit 850. The map receiving unit 850 analyzes GPS location information measured by the location measuring unit 130 or information about a base station or a WiFi access point accessed by the user equipment 800, and transmits a map information request including such information to the map server 810. At this time, the map information request may include radius information and scale information, and the radius information may be a distance from the center of the screen of the user equipment 800 to an edge thereof.

The map receiving unit 850 receives map information within a predetermined radius from a location calculated by using the GPS location information or the information about a base station or a WiFi access point, included in the map information request, from the map server 810 as a response to the map information request, and stores the received map information in the storage unit 120. The map information includes map data, POI information, and location information of the POI information.

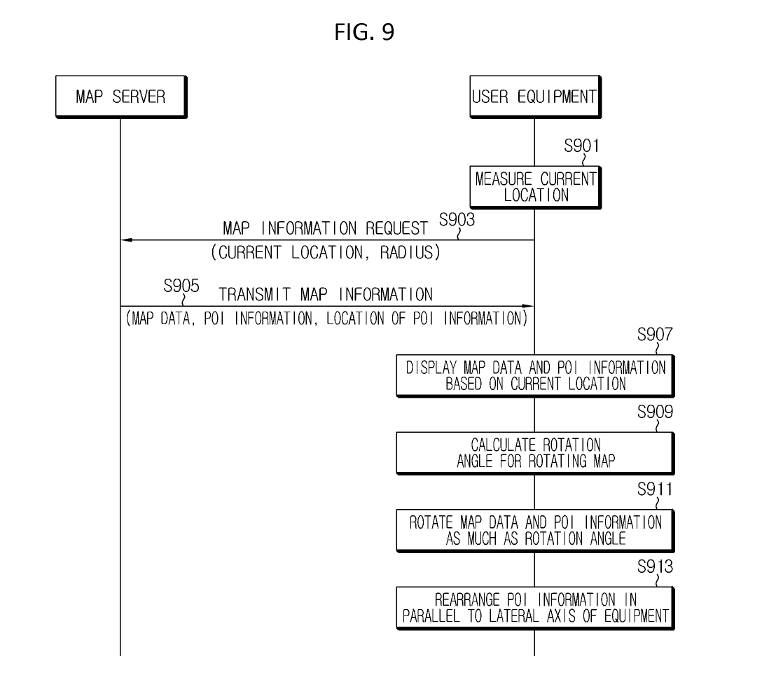

FIG. 9 is a flowchart for illustrating a method for rotating a map at user equipment according to another embodiment of the present disclosure.

Referring to FIG. 9, the user equipment 800 transmits the GPS location information or the information about a base station or a WiFi access point accessed by the user equipment 100 as well as the map information request to the map server 810 (S903). Here, the radius information may be a distance from the center of the screen of the user equipment 800 to an edge thereof.

The map server 810 receiving the map information request transmits map information within a predetermined radius from a location calculated by using the GPS location information or the information about a base station or a WiFi access point, included in the map information request, to the user equipment 800 (S905). Here, the map information includes map data, POI information, and location information of the POI information. The location information of the POI information is location information of the center of the POI information and may be latitude/longitude coordinates, or polar coordinates or orthogonal coordinates on a planar coordinate system using a current point of the user equipment 800 as a starting point.

The user equipment 800 stores the received map information and outputs a map to the display unit 110 by using the map data, the POI information, and the location information of the POI information. In detail, the user equipment 800 matches the current location with the center of the screen and matches the north on the map with the longitudinal axis of the user equipment 800. In addition, the user equipment 800 outputs a map so that the POI information is overlapped with the map data to be in parallel to the lateral axis of the user equipment 800 (S907).

After the map is displayed as described above, the user equipment 800 calculates a rotation angle for the rotation of the map (S909). For example, an input of a user interface, specifically an input of a scroll bar for rotating the map, may be analyzed to calculate a rotation angle according to the push of the scroll bar. In other case, a touch for rotating the map, input by the user on a touch screen having touch sensors, may be analyzed to calculate a rotation axis and a rotation angle of the map. In other case, the north on the map and the longitudinal axis of the user equipment may be separately received and then an angle between the longitudinal axis of the user equipment and the true north may be calculated by using a direction sensor.

After the rotation angle is calculated, the user equipment 800 rotates the map data and the POI information as much as the rotation angle (S911). After the rotation, the user equipment 800 rearranges the POI information to be in parallel to the lateral axis of the user equipment 800 (S913). An example of the rotation of the POI information according to the rotation of the map is already described above with reference to FIGS. 2 to 4. Even though this embodiment with reference to FIG. 9 has been described based on the case in which the POI information is arranged in parallel to the lateral axis of the user equipment, it may be easily understood from the above embodiments that the present disclosure may also be identically applied to the case of a string which should be arranged according to a geographic feature on the map in parallel to the corresponding geographic feature.

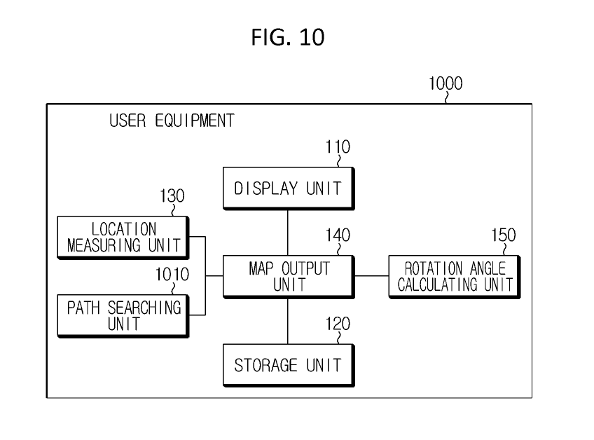

FIG. 10 is a block diagram showing user equipment for displaying a map according to still another embodiment of the present disclosure. In FIG. 10, the same reference symbols as in FIG. 1 have all functions and operations described with reference to FIG. 1.

Referring to FIG. 10, the user equipment 1000 of this embodiment further includes a path searching unit 1010. The path searching unit 1010 searches a path from a current location measured by the location measuring unit 130 to a destination input by the user by using the map data stored in the storage unit 120.

The map output unit 140 outputs a map to guide a way along the path searched by the path searching unit 1010.

The map output unit 140 outputs the map while displaying the current location measured by the location measuring unit 130 at the center of the screen so that the advancing direction is matched with the longitudinal axis of the user equipment 1000. At this time, the map output unit 140 may output the map so that a point corresponding to the current location is displayed at the center of the screen as described above. However, in order to improve visual recognition and predictability for the path information, the point corresponding to the current location may be displayed at the lower end of the screen so that a map, POI or the like corresponding to the advancing direction of the path based on the current location may be shown for a wider region. In addition, on occasions, such a point may also be displayed at an upper, lower, right or left position spaced apart from the center of the screen.

In the case the map rotates according to path guidance, the map output unit 140 rotates the POI information along with the map to be disposed in parallel to the lateral axis of the user equipment 1000 as described above. If the POI information should be arranged according to a geographic feature on the map to be in parallel to the corresponding geographic feature, an arrangement order of characters of the POI information, namely a string, as described above with reference to FIGS. 5A and 5B.

The map output unit 140 may rearrange only POI information within a predetermined radius based on the center of the current location to be in parallel to the lateral axis of the user equipment (including changing the arrangement order of the string) or rearrange only POI information within a predetermined distance from a path to be in parallel to the lateral axis of the user equipment (including changing the arrangement order of the string). This may reduce a computing burden.

The method of the present disclosure described above may be implemented as a program and stored in a recording medium (CD-ROM, RAM, ROM, floppy disc, hard disc, magneto-optical disc or the like) in a computer-readable form.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Although the drawings describe the operations in a specific order, one should not interpret that the operations are performed in a specific order as shown in the drawings or successively performed in a continuous order, or all the operations are performed to obtain a desired result. Multitasking or parallel processing may be advantageous under any environment. Also, it should be understood that all exemplary embodiments do not require the distinction of various system components made in this description. The program components and systems may be generally implemented as a single software product or multiple software product packages.

Various substitutions, changes and modifications can be made to the present disclosure described above by those having ordinary skill in the art within the scope of the present disclosure and the present disclosure is not limited to the above embodiments and the accompanying drawings.

What is claimed is:

1. User equipment, comprising:
a storage unit to separately store map data, POI (Point Of Interest) information, and location information of the POI information on the map data;
a map output unit to display the POI information overlapped with the map data on a screen based on the location information of the POI information in a way that the POI information is in parallel to a lateral axis of the user equipment; and
a rotation angle calculating unit to calculate a rotation angle for the rotation of the map data,
wherein the map output unit rotates the map data and the POI information, which are displayed on the screen in an overlapping state, according to the rotation angle, and rearranges the POI information to be in parallel to the lateral axis of the user equipment after rotation.

2. The user equipment according to claim 1, further comprising a direction sensor, wherein the rotation angle calculating unit calculates the rotation angle of the user equipment by using the direction sensor.

3. The user equipment according to claim 1, further comprising a direction sensor, wherein the rotation angle calculating unit calculates an angle between a longitudinal axis of the user equipment and the true north as the rotation angle by using the direction sensor.

4. The user equipment according to claim 1, wherein the rotation angle calculating unit calculates the rotation angle according to a map rotating command input by a user on a touch screen of the user equipment.

5. The user equipment according to claim 1, further comprising:
a location measuring unit to measure a current location; and
a map receiving unit to transmit the current location to a map server, receive map data, POI information and location information of a POI within a predetermined radius based on the current location from the map server, and store the data and information in the storage unit.

6. The user equipment according to claim 5,
wherein the location information of the POI is polar coordinates using the current location as a starting point, and
wherein the map output unit rotates the map data and the POI information based on the current location.

7. The user equipment according to claim 1,
wherein the POI information is characters of a string in which location information is stored for each character to be disposed on the map data according to a geographic feature on the map, and
wherein the map output unit disposes the characters of the string in parallel to the lateral axis of the user equipment.

8. The user equipment according to claim 7, wherein in the case the characters of the string are arranged in a direction opposite to a reference direction after rotation, the map output unit changes an arrangement order of the corresponding characters to conform to the reference direction.

9. The user equipment according to claim 1, wherein the map output unit arranges the POI information only within a predetermined radius based on a center of the screen to be disposed in parallel to the lateral axis after rotation.

10. The user equipment according to claim 1, wherein the map output unit arranges the POI information only within a predetermined distance from a path for guiding a way to a destination to be disposed in parallel to the lateral axis after rotation.

11. A method for displaying a map at user equipment, comprising:
separately storing map data, POI (Point Of Interest) information, and location information of the POI information on the map data;
displaying the POI information overlapped with the map data on a screen based on the location information of the POI information in a way that the POI information is in parallel to a lateral axis of the user equipment;
calculating a rotation angle for the rotation of the map data; and
rotating the map data and the POI information, which are displayed on a screen in an overlapping state, according to the rotation angle and rearranging the POI information to be in parallel to the lateral axis of the user equipment after rotation.

12. The method according to claim 11, wherein the calculation of the rotation angle comprises calculating the rotation angle of the user equipment by using a direction sensor of the user equipment.

13. The method according to claim 11, wherein the calculation of the rotation angle comprises calculating an angle between a longitudinal axis of the user equipment and the true north as the rotation angle by using a direction sensor.

14. The method according to claim 11, wherein the calculation of the rotation angle comprises calculating the rotation angle according to a map rotating command input by a user on a touch screen of the user equipment.

15. The method according to claim 11, before the storing, further comprising:
measuring a current location; and
transmitting the current location to a map server and receiving map data, POI information and location information of a POI within a predetermined radius based on the current location from the map server.

16. The method according to claim 15,
wherein the location information of the POI is polar coordinates using the current location as a starting point, and
wherein the rotating comprises rotating the map data and the POI information based on the current location.

17. The method according to claim 11,
wherein the POI information is characters of a string in which location information is stored for each character to be disposed on the map data according to a geographic feature on the map, and
wherein the displaying of the POI information comprises disposing the characters of the string in parallel to the lateral axis of the user equipment.

18. The method according to claim 17, wherein the rotating comprises changing an arrangement order of the characters to conform to a reference direction in the case the corresponding characters of the string are arranged in a direction opposite to the reference direction after rotation.

19. The method according to claim 11, wherein the rotating comprises arranging the POI information only within a predetermined radius based on a center of the screen to be disposed in parallel to the lateral axis after rotation.

20. The method according to claim 11,
wherein the displaying includes outputting a path for guiding a way to a destination, and
wherein the rotating comprises arranging the POI information only within a predetermined distance from the path to be disposed in parallel to the lateral axis after rotation.

21. A computer-readable recording medium on which program for executing the method defined in claim 11 is recorded.
